(19) United States
(12) Patent Application Publication
(10) Pub. No.: US 2009/0099685 A1
(43) Pub. Date: Apr. 16, 2009

(54) Method and Device for Transporting Articles with the Aid of a Display Device

(75) Inventor: DIETRICH BLASCHE, Singen (DE)

Correspondence Address: LERNER GREENBERG STEMER LLP, P O BOX 2480, HOLLYWOOD, FL, 33022-2480, US

(73) Assignee: Siemens Aktiengesellschaft, Munchen (DE)

(21) Appl. No.: 12/252,921

(22) Filed: Oct. 16, 2008

(30) Foreign Application Priority Data
Oct. 16, 2007 (DE) 10 2007 049 544.9

(51) Int. Cl. G06F 7/00; G06K 9/00; G06Q 50/00

(52) U.S. Cl. 700/226; 700/228

(57) ABSTRACT

A method and a device teach transporting a plurality of articles to destinations. Each article for transportation is provided with an identification of a destination and is transported to a destination. Each specified change in destination determines a destination that differs from the destination. The transportation is carried out using at least one display device. The display device displays each specified change in destination during the transportation. For each of the articles for transportation it is ascertained with which destination identification this article is provided. A check is made as to whether the display device is displaying a change in destination for this destination. If the display device displays a change in destination for this destination the article is transported to the destination whose determination the display device displays. Otherwise the article is transported to the destination with whose identification it is provided.

### CROSS-REFERENCE TO RELATED APPLICATION

This application claims the priority, under 35 U.S.C. §119, of German application DE 10 2007 049 544.9, filed Oct. 16, 2007; the prior application is herewith incorporated by reference in its entirety.

### BACKGROUND OF THE INVENTION

### Field of the Invention

The invention relates to a method and to a device for transporting a plurality of articles, in particular postal items, to destinations.

A postal item, for example a letter or a packet, is provided with a destination and is then transported to this destination. In the process the postal item usually passes through a sorting system at least twice. However it is possible for an addressee to communicate a delivery request and thereby determine, for example, that he has a new address for service. It is also possible that in the short term the sender wants a delivery to a different destination and, more precisely, after he has already provided the postal item with a destination or even after he has passed it to a transportation service provider. To execute this short-term change it is necessary according to the current prior art to provide the postal item with a label which identifies the changed destination. However this is only possible up until the postal item has passed through a sorting system for the last time.

U.S. patent disclosure No. 2003/0065625 A1 describes how postal items, in particular packets, are delivered to their addressees. The deliverer is provided with a portable display device. Before the deliverer looks for an addressee he checks whether he is at home. If not, a database is searched in order to ascertain alternative determinations for delivery, for example a second attempt to deliver on a different day. A corresponding additional delivery attempt is made if such a determination is found.

### SUMMARY OF THE INVENTION

It is accordingly an object of the invention to provide a method and a device for transporting articles with the aid of a display device which overcome the above-mentioned disadvantages of the prior art methods and devices of this general type, which method and device allow short-term changes in the stipulation of destinations to still be taken into account.

Each article for transportation is provided with a destination identification. Each article for transportation is transported from a distribution point to a destination. It is possible for an article to actually be transported to a different destination from that by which it is identified.

The method and the device provide the possibility of stipulating a change in destination for at least one destination identification. Each specified change in destination identification is a determination of a destination that differs from the destination identification. The changes in destination are stored in a database.

Transportation is carried out using at least one display device. The display device displays each specified change in destination at least intermittently during transportation. Changes in destination that are stored in the database are selected before the articles are removed from the distribution point. The selected changes in destination are transferred to the display device.

The now described steps are carried out for each of the articles for transportation. It is ascertained with which destination identification this article is provided. A check is made as to whether the display device is displaying a change in destination for the destination whose identification has been ascertained. In the event that the display device displays a change in destination for this destination, the article is transported to the destination whose determination the display device displays. Otherwise (i.e. if the display device does not display a change in destination for this destination) the article is transported to the destination with whose identification it is provided.

The short-term changes are still taken into account with the aid of the specified changes in destination; they are transferred to the display device. The display device displays these changes in destination. This makes it possible to still take into account even those changes in destination which are only specified when transportation of the article to this destination has already begun. If a specified change in destination exists for a destination then the displayed change in destination replaces the destination with which the article is identified.

The invention may be used for delivering postal items or even luggage to addressees, with each postal item or each item of luggage being provided with an identification of the destination or being provided therewith during the course of transportation. The destination can be for example an airplane or other modes of transportation. A change in destination results from short-term rebookings or from the fact that a mode of transportation is temporarily unavailable.

It is also possible to use the invention for transportation of articles to production facilities or to different production lines. The articles are for example containers with goods or workpieces or manufactured articles and are transported to their respective destinations by modes of transportation or modes of conveyance.

The display device preferably accompanies transportation of the articles to their respective destinations. This makes it possible to still display a change in destination “in the last few meters”. By way of example, a deliverer of postal items carries the display device with him while he looks for the destinations in order to deliver the respective postal items for these destinations. During delivery the display device shows him changes in destination for his delivery route.

Preferably only changes in destination that are actually required are displayed. This is affected by storing destination identifications which have actually been read. Only the changes in destination which refer to actually read destination identifications are displayed. The remaining destination identifications are not required for transportation of these articles.

In accordance with an added mode of the invention, there are the steps of: during transportation each of the articles is moved past a reader at least once; reading, via the reader, the destination identification with which the article is provided; storing a read destination identification in a read result database; and displaying, via the display device, only the change in the destination if the change in the destination refers to the destination whose destination identification has been read and stored.

In accordance with another feature of the invention, the display device is a portable display device which is carried along at least intermittently during transportation of the articles, and the changes in the destination are displayed during carrying-along.

In accordance with an additional mode of the invention, there are the steps of transporting all of the articles to a same intermediate point during transportation; and carrying along the display device during transportation of the articles from the intermediate point to the respective destination, and the display device displaying each change in the destination at least intermittently during carrying-along.

In accordance with another feature of the invention, the portable display device is connected to the database in which the changes in the destination are stored, and at least one stored change in the destination is transferred from the database to a data memory of the display device before transportation begins.

In accordance with another feature of the invention, the display device performs the steps of automatically ascertaining at least once which destinations are located in a specified surrounding area around the display device; and displaying only the changes in the destination whose destination determinations refer to a destination in a surrounding area.

In accordance with yet another feature of the invention, there is the step of providing at least one change in the destination with a validity period and the display device only displays the change in the destination if a transportation of the articles falls in the validity period.

In accordance with a further added feature of the invention, each destination identification with which the article is provided is associated with a specified destination area; one of the specified destination areas is selected; a decision is automatically made for each specified change in the destination as to whether the destination of the change belongs to the specified destination area or not; and the display device only displays a specified change in destination if the destination of the change belongs to the specified destination area.

In accordance with a concomitant mode of the invention, there is the step of displaying a transportation specification on the display device for each destination, the transportation specification being a determination of a parameter of transportation of an article to the destination to which the change in destination refers.

With the foregoing and other objects in view there is provided, in accordance with the invention, a device for transporting a plurality of articles. Each of the articles has a respective identification of a destination in a destination area, and is transported from a distribution point to a respective destination. The device includes a central database storing a change in a destination for at least one destination, each change in the destination determines a new destination that differs from the destination and a selection and transfer unit connected to the central database. The selection and transfer unit is configured for selecting changes in the destination for the destination area which are stored in the central database. At least one display device is provided for displaying transferred changes in the destination. The selection and transfer unit transfers the selected changes in the destination to the display device before the articles are removed from the distribution point.

In accordance with an added feature of the invention, a read result database stores read destination identifications of the articles and is connected to the selection and transfer unit; and the selection and transfer unit is configured for selecting the changes in the destination which refer to destinations whose destination identifications are stored in the read result database, and for transferring the selected changes in the destination to the display device.

In accordance with a concomitant feature of the invention, the portable display device contains a position-determining component and is configured to automatically ascertain at least once which destinations are located in a specified surrounding area around the display device, and only displays a change in the destination if it refers to a destination in the surrounding area.

Other features which are considered as characteristic for the invention are set forth in the appended claims.

Although the invention is illustrated and described herein as embodied in a method and a device for transporting articles with the aid of a display device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF SEVERAL VIEWS OF THE DRAWINGS

FIG. 1 is an illustration showing the route of three postal items through to the common postal delivery office; and

FIG. 2 is an illustration showing the continued route of the three postal items from FIG. 1 to their respective destinations.

### DETAILED DESCRIPTION OF THE INVENTION

In the exemplary embodiment the articles for transportation are postal items, for example letters or packets. Each postal item for transportation is provided with a respective identification of a destination. This destination is for example a combination of addressee and address for service, a combination of addressee and post-office box or box of a packet box system, or a post-office box of a receiver of numerous postal items, which box is identified by its own postcode.

En route to its destination each postal item passes through a sorting system at least twice and is then transported to a postal delivery office. Each postal delivery office is responsible for a specific region of destinations. This region of destinations is in turn divided into destination areas. The postal items which have been transported to a postal delivery office are distributed among the destination areas. At least one deliverer in each case transports the postal items of a destination area to their respective delivery spots.

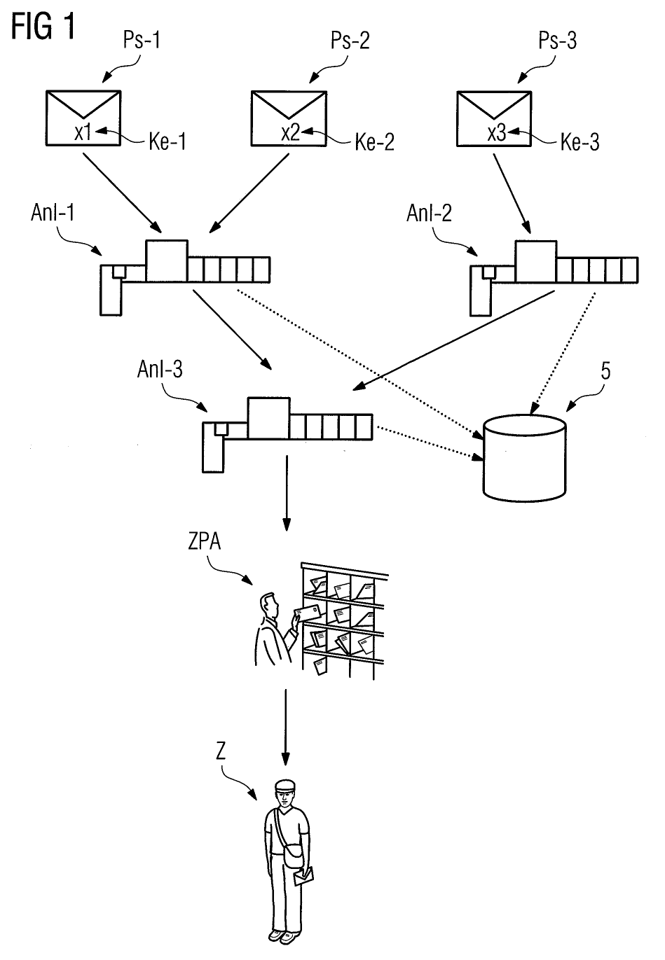

FIG. 1 shows by way of example the route of three postal items Ps-1, Ps-2 and Ps-3 to a common postal delivery office. Material flows are denoted by solid arrows, data flows by broken lines.

In FIG. 1 Ps-1 is provided with an identification Ke-1 of destination x1, Ps-2 with an identification Ke-2 of destination x2 and Ps-3 with an identification Ke-3 of destination x3. The two postal items Ps-1 and Ps-2 are transported to a sorting system Anl-1, postal item Ps-3 to a sorting system Anl-2. The sorting system Anl-1 reads the identifications Ke-1 and Ke-2 of the two postal items Ps-1 and Ps-2, and the sorting system Anl-2 reads the identification Ke-3 of postal item Ps-3. All three postal items are then transported onwards to a sorting system Anl-3. The postal items Ps-1, Ps-2 and Ps-3 pass through sorting system Anl-3 and are conveyed onwards to a common postal delivery office ZPA. All three sorting systems Anl-1, Anl-2, Anl-3 are connected to a read result database 5 which will be described below.

An addressee can specify a change in destination for a destination. This change in destination preferably determines the following:

the name of the addressee,

an old address for service, and

a new address for service for this addressee.

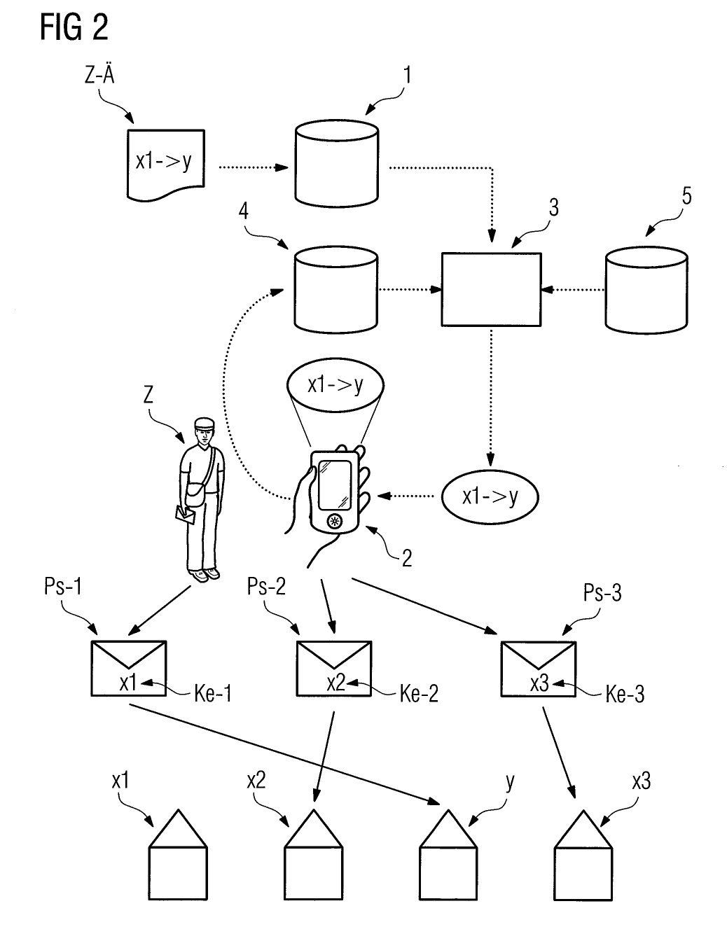

In the example of FIG. 2 a change in destination Z-Ä is specified. This change in destination Z-Ä determines that postal items which are provided with an identification of destination x1 should actually be delivered to destination y.

The change in destination can be open-ended or can be provided with a validity period. The change in destination is only displayed within the validity period. By way of example a change in destination determines that and to where an addresses has moved. An addressee can also specify that postal items to him should be stored in a postal delivery office for a specified period, for example because the addressee is away during this period. The new address for service is in this case the postal delivery office, determined by the note “poste restante”. An addressee can also specify that packets should be delivered to a specific neighbor for a specific period or should be placed in the garage. This change in destination therefore refers to a specific type of postal item. It is also possible to restrict a change in destination to postal items from certain senders. For example an addressee determines that within a specific period all postal items from companies or from authority X are to be delivered to neighbor C.

The addressee preferably communicates a change in destination to a transportation service provider by inputting the change in destination into a computer, and this computer transfers the change in destination to a central database via the internet. At least one computer of the transportation service provider has read access to this central database. It is also possible for the addressee to fill in a form and transfer it to the transportation service provider. It is also possible for the addressee to communicate a change in destination to the transportation service provider by phone (for example via a call center).

In addition to changes in destination an addressee can also communicate transportation specifications. These determine a parameter which should be heeded during transportation. For example the addressee can determine that postal items from specific senders or all postal items to him should be handled particularly carefully because they are fragile.

The changes in destination and the transportation specifications are stored in a central database in a form that can be evaluated by computer. Each change in destination and each transportation specification refers to a destination and contains at least one determination of a destination. A change in destination contains a determination of the old destination, with which a postal item may be identified, and a determination of the new destination. These determinations are preferably stored in encoded form. Once the validity period of a change in destination or a transportation specification has elapsed it is removed from the central database again.

As has already been illustrated, a deliverer transports all postal items of a specific destination area from the postal delivery office to their respective destinations. A plurality of deliverers from a postal delivery office typically works simultaneously in different destination areas, for example on different streets in the same district. All postal items which are to be transported to the destinations in his destination area are handed to the deliverer before transportation begins.

In the exemplary embodiment a display device is allocated to each deliverer. Each display device is connected to the central database before the deliverer transports, and therewith delivers, the postal items “of his” destination area. The display device is connected every morning by way of example to the central database before the deliverer begins transportation.

FIG. 2 shows the continued route of the three postal items Ps-1, Ps-2 and Ps-3 from FIG. 1 from the postal delivery office ZPA to their respective destinations. In the example of FIG. 2 a deliverer Z is responsible inter alia for the four delivery spots x1, x2, x3 and y. The deliverer Z uses a display device 2. The display device contains a data memory. An identifier of the display device is stored in the data memory. The destination area for which this display device is currently being used, and a determination of this destination area, is stored in a database for display devices. The destination area determination denotes the possible destinations belonging to this destination area.

A selection and transfer unit is connected to the central database, the display device database and the display device. The selection and transfer unit ascertains by read access to the display device the identifier of the display device. By read access to the display device database the selection and transfer unit ascertains the destination area, for which this display device is used, and the stored determination of the destination area.

The selection and transfer unit automatically selects all changes in destination in the central database which include as the old destination the determination of a destination of the destination area and which are either valid on an open-ended basis or of which the validity period includes the transfer instant. The selection and transfer unit also selects all transportation specifications which refer to transportation to a destination in the destination area and which are either valid on an open-ended basis or of which the validity period includes the transfer instant. The selection and transfer unit evaluates the ascertained determination of the destination area for this selection.

The selection and transfer unit is preferably also connected to a read result database. In this read result database each sorting system stores which destinations it ascertained on postal items as it read the destination identifications of the postal items passing through. The read results (read destinations) are stored in encoded form. Each read result (read destination identifications) is stored with the read instant and remains in the read result database for a specified period and is then deleted. The length of the period is such that the postal item is transported from the reading sorting system to the respective destination within this period.

In the example of FIG. 2 the selection and transfer unit 3 has read access to the central database 1, to the read result database 5 and to the display devices database 4. The selection and transfer unit 3 establishes that the change in destination Z-Ä refers to the destination area for which the display device 2 should be used.

The marking “currently relevant” is preferably provided with the instant at which the respective destination identification was read on any postal item. A more recent read instant overwrites an earlier read instant for the same destination identification. If the above-mentioned transportation period has elapsed since the most recent read instant, the identification “currently relevant” is deleted.

The selection and transfer unit checks each selected change in destination and each transportation specification for whether it refers to a destination which is stored in encoded form in the read result database. Only if the destination is stored in the read result database is a postal item which is provided with an identification of this destination transported. Only then is it necessary for the change in destination or transportation specification to be displayed. If the selection and transfer unit has selected a change in destination or transportation specification of a destination whose identification is stored in the read result database, the selection and transfer unit marks this change in destination or transportation specification “currently relevant”.

The selection and transfer unit transfers all selected changes in destination and transportation specifications to the display device. In the just-described embodiment containing the read result database the selection and transfer unit transfers only the changes in transportation and transportation specifications selected and marked “currently relevant”. All of these selected changes in destination and transportation specifications refer to destinations in the destination area of the display device. All changes in destination and transportation specifications marked “currently relevant” refer to postal items which are currently being transported. Because only the changes in destination and transportation specifications marked “relevant” are transferred the deliverer is only supplied with currently required information.

In the example of FIG. 2 the selection and transfer unit 3 selects the change in destination Z-Ä (y instead of x1) in the central database 1 and transfers this to the display device 2.

Following transfer the connection between the display device and the selection and transfer unit is preferably broken again.

The deliverer for the destination area activates the display device before he transports the postal items to the destinations in his destination area. The display device displays all the changes in destination and transportation specifications which are currently valid and which refer to a destination in the deliverer's destination area. In the embodiment comprising the read result database the display device displays only the changes in destination and transportation specifications which are currently relevant as they refer to destinations with which current postal items are identified.

The display device preferably has a screen on which it displays the currently valid changes in destination and transportation specifications. It is also possible for the display device to print out the currently valid changes in destination and transportation specifications and for the deliverer to take the printout with him.

There is preferably a sequence to the destinations of the destination area. This sequence establishes in which sequence the deliverer looks for the destinations and is called a route order in some embodiments. The display device preferably displays the changes in destination and transportation specifications in sorted order and, more precisely, sorted according to the sequence of destinations to which the changes in destination and transportation specifications refer in each case. This makes it easier for the deliverer to apply the changes in destination and transportation specifications to the current postal items.

It is possible for a change in destination and transportation specification to lead to the inability to deliver a postal item to the respective destination on this day. The deliverer puts such a postal item to one side and does not carry it with him during transportation.

In one embodiment the deliverer provides each postal item to one destination, to which a change in destination or transportation specification refers, with a corresponding delivery note. For example the display device indicates that each postal item to destination X should be delivered to neighbor C. The deliverer provides each postal item to destination X with a note indicating that this postal item should be delivered to neighbor C.

In a further embodiment the display device is configured as a portable device. FIG. 2 shows this embodiment.

The deliverer carries this portable display device 2 with him as he transports the postal items to their respective destinations. This embodiment saves the deliverer from having to provide the postal items with delivery notes manually. The deliverer activates the display device at any desired destination and reads the information which the display device shows.

In the example of FIG. 2 the portable display device 2 indicates to the deliverer Z that postal items which should be identified with the destination x1 should be delivered to destination y. The deliverer delivers the postal item Ps-1 to destination y therefore and not to destination X1 as indicated on postal item Ps-1. He delivers postal items Ps-2 and Ps-3 to x2 and x3 respectively, as is indicated on these two postal items.

The deliverer preferably marks a displayed change in destination and transportation specification when he has delivered all postal items to which this change in destination or transportation specification refers. The display device no longer shows marked changes in destination and transportation specifications on this day.

1. A method for transporting a plurality of articles, each of the articles is provided with a destination identification of a destination in a destination area, each of the articles is transported from a distribution point to a respective destination and a database is used in which a specified change in the destination is stored for at least one destination, each change in the destination determining a different destination that differs from the destination, transportation is carried out using at least one display device, changes in the destination are selected for the destination area and are stored in the database, selected changes in the destination are transferred from the database to the display device before the articles are removed from the distribution point, and the display device displaying each transferred change in the destination, which comprises the steps of:
ascertaining the destination identification each article is provided with; and
checking whether the display device is displaying a change in the destination for the destination whose destination identification has been ascertained;
if the display device displays a change in the destination for the destination, transporting the article to the different destination whose determination the display device displays as part of a displayed change in the destination; and
if the display device does not display a change in the destination for the destination, transporting the article to the destination with the destination identification the article is provided.

2. The method according to claim 1, which further comprises:
during transportation each of the articles is moved past a reader at least once;
reading, via the reader, the destination identification with which the article is provided;
storing a read destination identification in a read result database; and
displaying, via the display device, only the change in the destination if the change in the destination refers to the destination whose destination identification has been read and stored.

3. The method according to claim 1, wherein the display device is a portable display device which is carried along at least intermittently during transportation of the articles, and the changes in the destination are displayed during carrying-along.

4. The method according to claim 3, which further comprises:
transporting all of the articles to a same intermediate point during transportation; and
carrying along the display device during transportation of the articles from the intermediate point to the respective destination, and the display device displaying each change in the destination at least intermittently during carrying-along.

5. The method according to claim 3, wherein the portable display device is connected to the database in which the changes in the destination are stored, and at least one stored change in the destination is transferred from the database to a data memory of the display device before transportation begins.

6. The method according to claim 3, wherein the display device performs the steps of:
automatically ascertaining at least once which destinations are located in a specified surrounding area around the display device; and
displaying only the changes in the destination whose destination determinations refer to a destination in a surrounding area.

7. The method according to claim 1, which further comprises providing at least one change in the destination with a validity period and the display device only displays the change in the destination if a transportation of the articles falls in the validity period.

8. The method according to claim 1, wherein:
each destination identification with which the article is provided is associated with a specified destination area;
one of the specified destination areas is selected;
a decision is automatically made for each specified change in the destination as to whether the destination of the change belongs to the specified destination area or not; and
the display device only displays a specified change in destination if the destination of the change belongs to the specified destination area.

9. The method according to claim 1, which further comprises displaying a transportation specification on the display device for each destination, the transportation specification being a determination of a parameter of transportation of an article to the destination to which the change in destination refers.

10. A device for transporting a plurality of articles, each of the articles having a respective identification of a destination in a destination area, and is transported from a distribution point to a respective destination, the device comprising:
a central database storing a change in a destination for at least one destination, each change in the destination determining a new destination that differs from the destination;
a selection and transfer unit connected to said central database, said selection and transfer unit configured for selecting changes in the destination for the destination area which are stored in said central database; and
at least one display device for displaying transferred changes in the destination, said selection and transfer unit transferring the selected changes in the destination to said display device before the articles are removed from the distribution point.

11. The device according to claim 10,
further comprising a read result database storing read destination identifications of the articles and connected to said selection and transfer unit; and
wherein said selection and transfer unit is configured for selecting the changes in the destination which refer to destinations whose destination identifications are stored in said read result database, and for transferring the selected changes in the destination to said display device.

12. The device according to claim 10, wherein said display device is a portable display device which is configured such that said display device can be carried along during transportation of the articles and the changes in the destination are displayed during transportation.

13. The device according to claim 12, wherein said portable display device contains a position-determining component and is configured to automatically ascertain at least once which destinations are located in a specified surrounding area around said display device, and only displays a change in the destination if it refers to a destination in the surrounding area.

14. A method for transporting a plurality of articles, which comprises the steps of:
providing each of the articles with a destination identification of a destination in a destination area;
transporting each of the articles from a distribution point to the destination by performing the steps of:
using a database in which a specified change in the destination is stored for at least one destination, each change in the destination determines a different destination that differs from the destination;
carrying out a transportation of the articles using at least one display device;
selecting for the destination area changes in the destination and storing the changes in the destination in the database;
transferring selected changes in the destination from the database to the display device before the articles are removed from the distribution point, the display device displaying each transferred change in the destination;
ascertaining the destination identification each article is provided with;
checking whether the display device is displaying a change in destination for the destination whose identification has been ascertained;
if the display device displays a change in the destination for the destination, transporting the article to the different destination whose determination the display device displays as part of a displayed change in the destination; and
if the display device does not display a change in destination for the destination, transporting the article to the destination with whose identification the article is provided.
